(19) United States
(12) Patent Application Publication
(10) Pub. No.: US 2006/0290250 A1
(43) Pub. Date: Dec. 28, 2006

(54) Snow goggle

(76) Inventor: Ching-Wen Kuo, Fong Shan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/168,686

(22) Filed: Jun. 28, 2005

(51) Int. Cl. H01J 61/52

(52) U.S. Cl. 313/23

(57) ABSTRACT

A snow goggle includes an inner lens having an upper electrode and a lower electrode. The distance between the upper electrode and the lower electrode at the mediate portion thereof is substantially equal to that between the upper electrode and the lower electrode at each of the two sides thereof. The mediate portion of each of the upper electrode and the lower electrode has a relatively smaller resistance, and each of the two sides of each of the upper electrode and the lower electrode has a relatively greater resistance, so that the inner lens has a constant temperature. Thus, the whole structure of the inner lens has a constant distance and a constant temperature, thereby enhancing the frost and snow cleaning effect of the snow goggle.

### BACKGROUND OF THE INVENTION

1. Field of the Invention

The present invention relates to one of a pair of snow goggles, and more particularly to a snow goggle having an enhanced frost and snow cleaning effect.

2. Description of the Related Art

A conventional snow goggle comprises an inner lens, an outer lens mounted on and separated from the inner lens, and an air chamber formed between the inner lens and the outer lens. The inner lens has an upper end formed with an upper electrode made of a silver paste and a lower end formed with a lower electrode made of a silver paste. The upper electrode and the lower electrode co-operate to provide a defrosting effect.

However, the distance between the upper electrode and the lower electrode at the mediate portion thereof is different from that between the upper electrode and the lower electrode at each of the two sides thereof, so that a temperature differential is produced between the mediate portion and the two sides of the upper electrode and the lower electrode. When the temperature at the mediate portion of the upper electrode and the lower electrode is too low, the defrosting effect is decreased, and when the temperature at the two sides of the upper electrode and the lower electrode is too high, the upper electrode and the lower electrode are easily worn out. In addition, the outer lens is easily scraped or scratched, thereby affecting the viewing effect of the outer lens. Further, the outer lens has an insufficient temperature, so that the outer lens cannot clean the frost or snow, thereby affecting the viewing effect of the outer lens.

### SUMMARY OF THE INVENTION

In accordance with the present invention, there is provided a snow goggle, comprising an inner lens having an upper end formed with an upper electrode made of a silver paste and a lower end formed with a lower electrode made of a silver paste. Each of the upper electrode and the lower electrode has a mediate portion and two sides. The mediate portion of the lower electrode has a relatively greater width so that a distance between the upper electrode and the lower electrode at the mediate portion thereof is substantially equal to that between the upper electrode and the lower electrode at each of the two sides thereof. The mediate portion of each of the upper electrode and the lower electrode has a relatively smaller resistance, and each of the two sides of each of the upper electrode and the lower electrode has a relatively greater resistance, so that the inner lens has a constant temperature.

The primary objective of the present invention is to provide a snow goggle having an enhanced frost and snow cleaning effect.

Another objective of the present invention is to provide a snow goggle, wherein the whole structure of the inner lens has a constant distance and a constant temperature, thereby enhancing the frost and snow cleaning effect of the snow goggle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a snow goggle in accordance with the preferred embodiment of the present invention;

FIG. 2 is a plan view of an inner lens of the snow goggle as shown in FIG. 1; and

FIG. 3 is a plan cross-sectional view of a snow goggle in accordance with another preferred embodiment of the present invention.

### DETAILED DESCRIPTION OF THE INVENTION

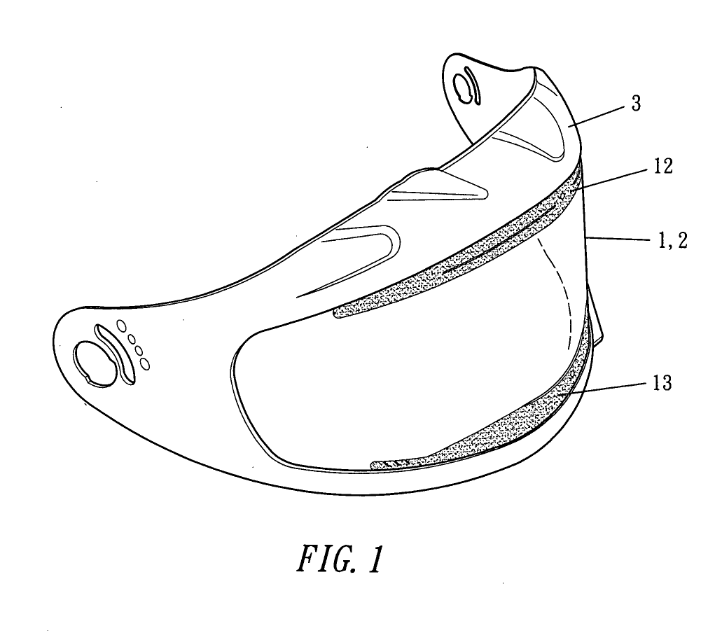

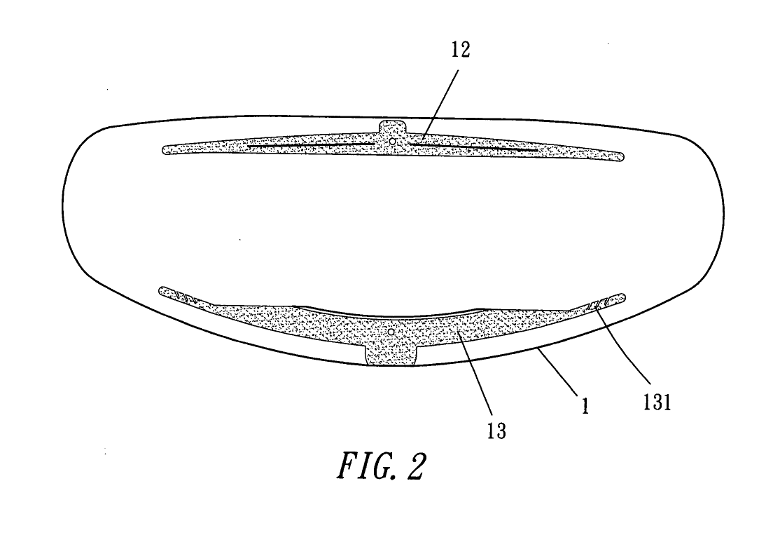

Referring to the drawings and initially to FIGS. 1 and 2, a snow goggle in accordance with the preferred embodiment of the present invention comprises a frame 3, an inner lens 1 mounted in the frame 3, and an outer lens 2 mounted on the inner lens 1 and located in the frame 3.

The inner lens 1 is made of a transparent plastic material, such as PC, PET or the like. The inner lens 1 has an outer side formed with an ITO (indium tin oxide) film.

The inner lens 1 has an upper end formed with an upper electrode 12 made of a silver paste and a lower end formed with a lower electrode 13 made of a silver paste. Each of the upper electrode 12 and the lower electrode 13 has a mediate portion and two sides.

The mediate portion of the lower electrode 13 has a relatively greater width so that a distance between the upper electrode 12 and the lower electrode 13 at the mediate portion thereof is substantially equal to that between the upper electrode 12 and the lower electrode 13 at each of the two sides thereof. Preferably, the mediate portion of the lower electrode 13 has a relatively greater thickness.

The mediate portion of each of the upper electrode 12 and the lower electrode 13 has a relatively smaller resistance, and each of the two sides of each of the upper electrode 12 and the lower electrode 13 has a relatively greater resistance, so that the inner lens 1 has a constant temperature. Each of the two sides of the lower electrode 13 has a serrated shape and is formed with a plurality of slits 131 to increase the resistance. Thus, the whole-structure of the inner lens 1 has a constant distance and a constant temperature. In addition, the inner lens 1 is processed by a liquid medicine to have a frost-proof effect.

The outer lens 2 is processed by a liquid medicine to have a frost-proof and scrape-proof effect. Thus, the outer lens 2 has a protective layer to prevent the outer lens 2 from being scraped or scratched, thereby enhancing the viewing effect of the outer lens 2.

When in use, the mediate portion of each of the upper electrode 12 and the lower electrode 13 has a relatively smaller resistance, and the mediate portion of the lower electrode 13 has a relatively greater thickness to reduce the resistance. Thus, the current is increased when the resistance is reduced, so that the temperature is increased when the current is increased so as to increase the temperature of the mediate portion (the golden zone) of each of the upper electrode 12 and the lower electrode 13, thereby enhancing the defrosting effect. In addition, the mediate portion of the lower electrode 13 has a relatively greater width so that the distance between the upper electrode 12 and the lower electrode 13 at the mediate portion thereof is substantially equal to that between the upper electrode 12 and the lower electrode 13 at each of the two sides thereof. Thus, the whole structure of the inner lens 1 has a constant distance and a constant temperature.

Accordingly, the whole structure of the inner lens 1 has a constant distance and a constant temperature, thereby enhancing the frost and snow cleaning effect of the snow goggle.

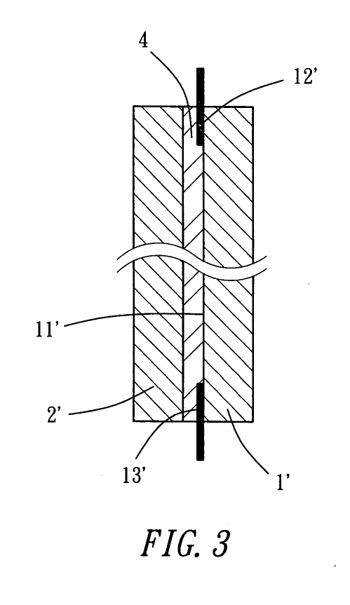

Referring to FIG. 3, a snow goggle in accordance with another preferred embodiment of the present invention comprises an inner lens 1′, an outer lens 2′, and an optical gel 4 mounted between the inner lens 1′ and the outer lens 2′. The inner lens 1′ has an outer side formed with an ITO (indium tin oxide) film 11′. The inner lens 1′ has an upper end formed with an upper electrode 12′ made of a silver paste and a lower end formed with a lower electrode 13′ made of a silver paste. Thus, the ITO film 11′ has electrically and thermally conducting features, so that the inner lens 1′ and the outer lens 2′ reach a constant temperature, thereby achieving the frost and snow cleaning effect instantaneously.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A snow goggle, comprising:
an inner lens having an upper end formed with an upper electrode made of a silver paste and a lower end formed with a lower electrode made of a silver paste; wherein:
each of the upper electrode and the lower electrode has a mediate portion and two sides;
the mediate portion of the lower electrode has a relatively greater width so that a distance between the upper electrode and the lower electrode at the mediate portion thereof is substantially equal to that between the upper electrode and the lower electrode at each of the two sides thereof;
the mediate portion of each of the upper electrode and the lower electrode has a relatively smaller resistance, and each of the two sides of each of the upper electrode and the lower electrode has a relatively greater resistance, so that the inner lens has a constant temperature.

2. The snow goggle in accordance with claim 1, wherein the mediate portion of the lower electrode has a relatively greater thickness.

3. The snow goggle in accordance with claim 1, wherein the each of the two sides of the lower electrode has a serrated shape and is formed with a plurality of slits to increase the resistance.

4. The snow goggle in accordance with claim 1, wherein the whole structure of the inner lens has a constant distance and a constant temperature.

5. The snow goggle in accordance with claim 1, wherein the inner lens is processed by a liquid medicine to have a frost-proof effect.

6. The snow goggle in accordance with claim 1, further comprising an outer lens mounted on the inner lens.

7. The snow goggle in accordance with claim 6, further comprising an optical gel mounted between the inner lens and the outer lens.

8. The snow goggle in accordance with claim 6, wherein the outer lens is processed by a liquid medicine to have a frost-proof and scrape-proof effect.

9. The snow goggle in accordance with claim 1, wherein the inner lens has an outer side formed with an ITO (indium tin oxide) film.
